(19) United States
(12) Patent Application Publication
(10) Pub. No.: US 2014/0308982 A1
(43) Pub. Date: Oct. 16, 2014

(54) ARRANGEMENT FOR PHYSICALLY LOCATING FIELD DEVICES IN PROCESS INSTALLATIONS

(71) Applicant: ABB Technology AG, Zurich (CH)

(72) Inventors: Roland BRAUN, Niederkassel Lulsdorf (DE); Alexander Kaiser, Heddesheim (DE)

(73) Assignee: ABB Technology AG, Zurich (CH)

(21) Appl. No.: 14/250,926

(22) Filed: Apr. 11, 2014

(30) Foreign Application Priority Data
Apr. 11, 2013 (DE) 202013003415.7

(51) Int. Cl. G01S 5/02

(52) U.S. Cl. CPC G01S 5/0205
USPC 455/457

(57) ABSTRACT

The disclosure relates to an arrangement for physically locating field devices in process installations, in which each field device can be identified and the installation location of each field device in the process installation is known. In order to control and find a field device in the shortest possible time, a mobile device having at least one memory and a graphical display device is provided, at least one graphical representation of the field device and a topological coordinate specification of the installation location of the respective field device being assigned to the particularized data relating to the respective field device and being stored in a retrievable manner in the at least one memory.

### RELATED APPLICATION(S)

This application claims priority to German Patent Application DE 20 2013 003 415.7 filed in Germany on Apr. 11, 2013. The entire contents of this application is hereby incorporated by reference in its entirety.

### FIELD

The disclosure relates to an arrangement for physically locating field devices in process installations.

### BACKGROUND INFORMATION

In complex and/or spatially extended process installations, a multiplicity of field devices for controlling the technical process can be installed in the process installation. The multiplicity of field devices can include measuring sensors for physical variables, such as pressure, temperature, flow rate, concentration and the like, as well as actuators for actuating valves, flaps, conveying means and the like.

In the event of a fault or damage in the installation, the faulty field device is identified and located in the shortest time in order that the repair or replacement of the faulty field device can be performed in situ.

Field devices of a process installation, for example, can be incorporated in a hierarchical structure of control loops including closed-loop control devices. For example, the closed-loop control devices can be combined in an open-loop control installation matched to the process installation. The open-loop control installation may have a central or decentralized structure. In addition, each field device in a given process installation can be uniquely identified and logically assigned to an installation part using the means of the open-loop control installation. However, the associated logical localization of each field device can be insufficient to locate a faulty field device in the process installation in situ in an appropriate time.

Identification systems, for example according to DIN 6779, are known, according to which each field device in a given process installation is identified according to the installation location. However, the process of finding a field device presupposes knowledge of the structure of the process installation. In addition, a standardized naming convention is not always used. Thus, maintenance personnel have to handle different customer-specific identification systems.

In addition, the persons for maintaining an installation are different from those who constructed the installation. Fluctuating maintenance personnel can necessitate a certain type of training for each installation. In addition, service employees are often not allocated only to a particular installation.

DE 101 24 266 A1 discloses a system for physically locating field devices in process installations, in which each field device can be uniquely identified and can be connected to an open-loop control installation via a communication network and which can have a locally oriented hierarchical structure and an installation identification directed thereto. In this case, a stationary device and a mobile device can be provided, the stationary device being assigned to the field device. Detailed information on the position of the installation location of the field device can be stored in a retrievable manner in a non-volatile memory of the stationary device. The mobile device can be provided with a processing unit, a keyboard, a display unit and a communication device for wireless communication. Retrieved information on the position of the installation location of the field device in the process installation can be visualized using the display unit.

### SUMMARY

An arrangement is disclosed for physically locating field devices in process installations, in which each field device can be identified and an installation location for each field device in the process installation is known, the arrangement comprising: a mobile device having at least one memory; and a graphical display device, wherein the at least one memory is configured to store, and does store, in a retrievable manner, at least one graphical representation of a field device, a topological coordinate specification of an installation location of the field device, and device specific data relating to the field device.

A mobile device is disclosed for physically locating field devices in process installations, in which each field device can be identified and an installation location for each field device in the process installation is known, the mobile device comprising: at least one memory, the at least one memory configured to store, and containing, in a retrievable manner, at least one graphical representation of a field device, a topological coordinate specification of the installation location of a field device, and device specific data relating to the field device; and a graphical display device connected to the memory device.

### BRIEF DESCRIPTION OF THE DRAWINGS

The disclosure is explained below with reference to the exemplary embodiment shown in the drawing. In the drawing:

FIG. 1 illustrates a mobile device for finding field devices in a process installation in accordance with an exemplary embodiment.

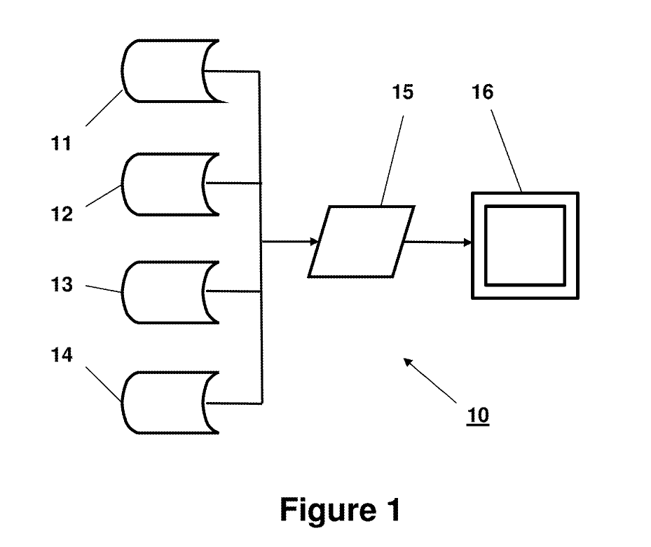

### DETAILED DESCRIPTION

In accordance with an exemplary embodiment, the disclosure describes a means, which allows a field device in the process installation to be able to be purposefully controlled and found in the shortest possible time.

The disclosure is based on a process installation in which each field device can be uniquely identified and the location of each of the field devices in the process installation is known. In addition to process automation field devices, a field device in the sense of the present disclosure can include, for example, infrastructure devices such as switches, energy distributors, switch boxes and the like.

In accordance with an exemplary embodiment, the arrangement can include a mobile device having at least one memory and a graphical display device, at least one graphical representation of the field device and a topological coordinate specification of the installation location of the respective field device being assigned to the particularized data relating to the respective field device and being stored in a retrievable manner in the memory.

This visual assistance for the maintenance personnel can facilitate the process of finding the field device sought in a process installation.

In accordance with an exemplary embodiment, the topological coordinate specification of the installation location can be embedded in an environment map on which further objects of the installation location can be recorded.

In accordance with an exemplary embodiment, the field device can be easier to find in the context of surrounding infrastructure features. In addition to further field devices, these may also include routes, cable guides, pipelines, machines and the like.

In accordance with an exemplary embodiment, the topological coordinate specification of the installation location can be supplemented with a height indication.

In accordance with an exemplary embodiment, the field device can be easier to find, for example, when its installation location is outside the field of vision of the moving maintenance personnel.

In accordance with an exemplary embodiment, the mobile device can have a means for determining its own position.

In accordance with an exemplary embodiment, the field device can be easier to find by means of the local reference to the position of the maintenance personnel.

In accordance with an exemplary embodiment, the device's own position can be recorded in the environment map for the installation location of the field device sought.

In accordance with an exemplary embodiment, the field device can be easier to find by means of the local reference to the position of the maintenance personnel in the context of surrounding infrastructure features.

An exemplary arrangement according to the disclosure can be embedded in a device management system. This can achieve a relatively high level of acceptance with the maintenance personnel. In addition, an arrangement according to the disclosure can be suitable for reducing the maintenance costs since both the preparation cost and the process of actually finding a field device sought can be reduced.

The mobile device 10 (e.g., any known or to-be-developed wireless communication transreceiver device with an on-board processer) can have at least one memory 15 and a graphical display device 16. At least one graphical representation 12 of the field device and a topological coordinate specification 13 of the installation location of the respective field device can be assigned to the particularized data 11 relating to the respective field device and can be stored in the memory 15 in a retrievable manner for display on the display device 16. In accordance with an exemplary embodiment, a provision can be made for the graphical representation 12 to include a photo of the field device.

In an exemplary embodiment of the disclosure, the topological coordinate specification 13 of the installation location can be embedded in an environment map 14 on which further objects of the installation location can be recorded. For example, routes, cable guides, pipelines, machines and the like may be provided as further objects. In this case, the environment map 14 may be in the form of an outline of the process installation or part of the latter.

In an exemplary embodiment of the disclosure, the topological coordinate specification 13 of the installation location can be supplemented with a height indication.

In an exemplary embodiment of the disclosure, the mobile device 10 can have means for determining its own position. For example, the mobile device 10 may be provided with a GPS receiver.

In accordance with an exemplary embodiment, the mobile device's 10 own position can be recorded in the environment map 14 for the installation location of the field device sought.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Mobile device

11 Particularized data

12 Graphical representation

13 Topological coordinate specification

14 Environment map

15 Memory

16 Display device

What is claimed is:

1. An arrangement for physically locating field devices in process installations, in which each field device can be identified and an installation location for each field device in the process installation is known, the arrangement comprising:
a mobile device having at least one memory; and
a graphical display device, wherein the at least one memory is configured to store, and does store, in a retrievable manner, at least one graphical representation of a field device, a topological coordinate specification of an installation location of the field device, and device specific data relating to the field device.

2. The arrangement as claimed in claim 1, wherein the topological coordinate specification of the installation location is embedded in an environment map on which further objects of the installation location are recorded.

3. The arrangement as claimed in claim 2, wherein the topological coordinate specification of the installation location includes a height indication of the field device.

4. The arrangement as claimed in claim 1, wherein the topological coordinate specification of the installation location includes a height indication of the field device.

5. The arrangement as claimed in claim 1, wherein the mobile device comprises:
means for determining a position of the mobile device.

6. The arrangement as claimed in claim 5, wherein the means for determining the position of the mobile device is a GPS receiver.

7. The arrangement as claimed in claim 5, wherein the at least one memory and mobile device are configured to record a position of the mobile device in an environment map for the installation location of the field device which is being sought.

8. The arrangement as claimed in claim 1, wherein the at least one graphical representation includes a photo of the field device.

9. The arrangement as claimed in claim 1, wherein the field device is an infrastructure device.

10. The arrangement as claimed in claim 9, wherein the infrastructure device is a switch, energy distributor, and/or switch box.

11. A mobile device for physically locating field devices in process installations, in which each field device can be identified and an installation location for each field device in the process installation is known, the mobile device comprising:
at least one memory, the at least one memory configured to store, and containing, in a retrievable manner, at least one graphical representation of a field device, a topological coordinate specification of the installation location of a field device, and device specific data relating to the field device; and
a graphical display device connected to the memory device.

12. The mobile device as claimed in claim 11, wherein the topological coordinate specification of the installation location is embedded in an environment map on which further objects of the installation location are recorded.

13. The mobile device as claimed in claim 12, wherein the topological coordinate specification of the installation location includes a height indication of the field device.

14. The mobile device as claimed in claim 11, wherein the topological coordinate specification of the installation location includes a height indication of the field device.

15. The mobile device as claimed in claim 11, wherein the mobile device comprises:
means for determining a position of the mobile device.

16. The mobile device as claimed in claim 15, wherein the means for determining the position of the mobile device is a GPS receiver.

17. The mobile device as claimed in claim 15, wherein the at least one memory and mobile device are configured to record a position of the mobile device in an environment map for the installation location of the field device which is being sought.

18. The mobile device as claimed in claim 11, wherein the at least one graphical representation includes a photo of the field device.

19. The mobile device as claimed in claim 11, wherein the field device is an infrastructure device.

20. The mobile device as claimed in claim 19, wherein the infrastructure device is a switch, energy distributor, and/or switch box.
